(19) United States
(12) Patent Application Publication
(10) Pub. No.: US 2024/0193817 A1
(43) Pub. Date: Jun. 13, 2024

(54) IMAGE PROCESSING SYSTEM, ENCODING METHOD, AND COMPUTER-READABLE RECORDING MEDIUM STORING ENCODING PROGRAM

(71) Applicant: FUJITSU LIMITED, Kawasaki-shi (JP)

(72) Inventors: Tomonori KUBOTA, Kawasaki (JP); Tomoyuki UENO, Kawasaki (JP)

(73) Assignee: FUJITSU LIMITED, Kawasaki-shi (JP)

(21) Appl. No.: 18/444,823

(22) Filed: Feb. 19, 2024

Related U.S. Application Data
(63) Continuation of application No. PCT/JP2021/035014, filed on Sep. 24, 2021.

(51) Int. Cl. G06T 9/00; G06T 3/40

(52) U.S. Cl. CPC G06T 9/00; G06T 3/40

(57) ABSTRACT

An image processing system includes: a memory; and a processor coupled to the memory and configured to; encode, when a plurality of process are performed, by AI, on decoded data which is generated by decoding image data which is encoded, the image data at a compression rate which is determined such that a result of each of the plurality of process acquires a specific accuracy.

### CROSS-REFERENCE TO RELATED APPLICATION

This application is a continuation application of International Application PCT/JP2021/035014 filed on Sep. 24, 2021 and designated the U.S., the entire contents of which are incorporated herein by reference.

### FIELD

The embodiment relates to an image processing system, an encoding apparatus, an encoding method, and an encoding program.

### BACKGROUND

In general, when image data is recorded or transmitted, a data size is reduced by encoding, thereby reducing a recording cost and a transmission cost.

On the other hand, in a case where the image data is recorded or transmitted for the purpose of being used for a process by Artificial Intelligence (AI), a method of encoding the image data by increasing a compression rate of each region to a limit at which the AI appropriately processes decoded data (for example, encoding the image data at a limit compression rate) is considered.

Related art is disclosed in Japanese Laid-Open Patent Publication No. 2021-013146 and International Publication Pamphlet No. WO 2020/162495.

### SUMMARY

However, a case is also assumed in which a plurality of processes by AI are included and the limit compression rate is different for each process. For example, it is assumed that the plurality of processes include an object detection process by AI and a distance measurement process by AI for a detected object. In this case, if the encoding is performed at the limit compression rate suitable for the object detection process, the decoded image having an image quality required for the distance measurement process may not be obtained. For example, although the object may be detected from the decoded data, a situation may arise in which an appropriate distance measurement process may not be performed on the detected object.

According to an aspect, an object is to generate the decoded data that may be used in the plurality of processes by an AI.

According to one aspect of the embodiments, an image processing system includes: a memory; and a processor coupled to the memory and configured to; encode, when a plurality of process are performed, by AI, on decoded data which is generated by decoding image data which is encoded, the image data at a compression rate which is determined such that a result of each of the plurality of process acquires a specific accuracy.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system configuration of an image processing system;

FIG. 2 is a diagram illustrating an example of a hardware configuration of an encoding apparatus and an image analysis apparatus;

FIG. 3 is a diagram illustrating a specific example of a compression rate control process;

FIG. 4 is a first flowchart illustrating a flow of the compression rate control process.

FIG. 5A is a first diagram illustrating an example of a control result of a compression rate.

FIG. 5B is a second diagram illustrating an example of a control result of a compression rate.

FIG. 6 is a diagram illustrating an example of a system configuration of an image processing system in a specific phase;

FIG. 7 is a diagram illustrating an example of a result of a process by each processing unit.

FIG. 8 is a diagram illustrating an example of rule information;

FIG. 9 is a flowchart illustrating a flow of a rule information generation process.

FIG. 10 is a diagram illustrating an example of a system configuration of an image processing system in an encoding phase;

FIG. 11 is a second flowchart illustrating a flow of a compression rate control process.

FIG. 12 is a diagram illustrating an example of a result of switching of compression rates;

### DESCRIPTION OF EMBODIMENTS

Hereinafter, each embodiment will be described with reference to the accompanying drawings. Note that in the present specification and drawings, components having substantially the same functional configuration are denoted by the same reference numerals, and redundant description thereof will be omitted.

### First Embodiment

### <System Configuration of Image Processing System>

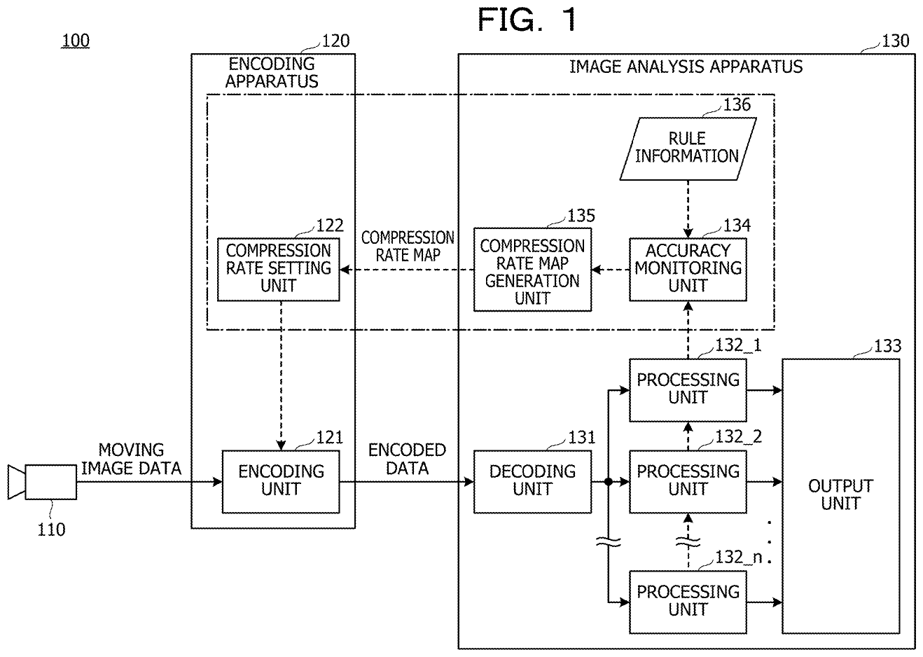

First, a system configuration of an image processing system including an encoding apparatus and an image analysis apparatus according to a first embodiment will be described. FIG. 1 is a diagram illustrating an example of the system configuration of the image processing system. As illustrated in FIG. 1, the image processing system 100 includes an imaging apparatus 110, an encoding apparatus 120, and an image analysis apparatus 130. In the image processing system 100, the encoding apparatus 120 and the image analysis apparatus 130 are communicably coupled via a network (not illustrated).

The imaging apparatus 110 performs imaging at a predetermined frame cycle and transmits moving image data to the encoding apparatus 120.

An encoding program is installed in the encoding apparatus 120, and the encoding program is executed, whereby the encoding apparatus 120 functions as an encoding unit 121 and a compression rate setting unit 122.

The encoding unit 121 encodes image data of each frame included in the moving image data to generate encoded data. When generating the encoded data, the encoding unit 121 encodes the image data using a compression rate map (a map indicating the compression rate of each region in the case of encoding the image data at a different compression rate for each region) set by the compression rate setting unit 122. Further, the encoding unit 121 transmits the generated encoded data to the image analysis apparatus 130.

Every time the compression rate setting unit 122 acquires the compression rate map generated by the image analysis apparatus 130, the compression rate setting unit 122 sets the acquired compression rate map in the encoding unit 121. Thus, the compression rate of each region when the encoding unit 121 encodes the image data is appropriately controlled.

An image analysis program is installed in the image analysis apparatus 130. The image analysis apparatus 130 functions as a decoding unit 131, processing units 132_1 to 132-n, an output unit 133, an accuracy monitoring unit 134, and a compression rate map generation unit 135 by executing the image analysis program.

The decoding unit 131 decodes the encoded data transmitted from the encoding apparatus 120 and generates decoded data.

Each of the processing units 132_1 to 132_n performs a process by the AI on the decoded data in parallel. n types of processes (n is an integer of 2 or more) by the AI may include, for example, a process of identifying an attribute of each of n types of different objects included in the decoded data (for example, a process of identifying the attribute of a pedestrian, a process of identifying the attribute of a vehicle, or the like).

The output unit 133 outputs a result of a process performed on the decoded data by each of the processing units 132_1 to 132_n.

The accuracy monitoring unit 134 performs an accuracy monitoring process based on rule information 136. It is assumed that the rule information 136 defines a compression rate determination rule when the processing units 132_1 to 132_n perform the process by the AI on the decoded data in parallel. For example, in the case of the present embodiment, it is assumed that the rule information 136 defines that “the compression rate is determined so that a result with a predetermined accuracy or higher is obtained in any process by the AI”.

Therefore, the accuracy monitoring unit 134 monitors whether or not a predetermined accuracy is obtained for the result of each process performed on the decoded data by the processing units 132_1 to 132_n. In addition, when the accuracy monitoring unit 134 determines that the predetermined accuracy is not obtained for the result of any process by the processing units 132_1 to 132_n, the accuracy monitoring unit 134 determines a new compression rate so that the predetermined accuracy is obtained.

When the accuracy monitoring unit 134 determines the new compression rate, the compression rate map generation unit 135 generates a compression rate map based on the determined new compression ratio. In the present embodiment, the compression rate map generation unit 135 generates the compression ratio map in which the determined new compression rate is stored in the entire region of the image data. The compression rate map generation unit 135 generates the compression ratio map each time the new compression ratio is determined, and transmits the generated compression ratio map to the encoding device 120.

Note that in the image processing system 100 of FIG. 1, each unit surrounded by a dashed-dotted line executes a compression rate control process of appropriately controlling the compression rate of each region while each unit of the encoding unit 121, the decoding unit 131, the processing units 132_1 to 132-n, and the output unit 133 is operating.

### <Hardware Configuration of Encoding Device and Image Analysis Device>

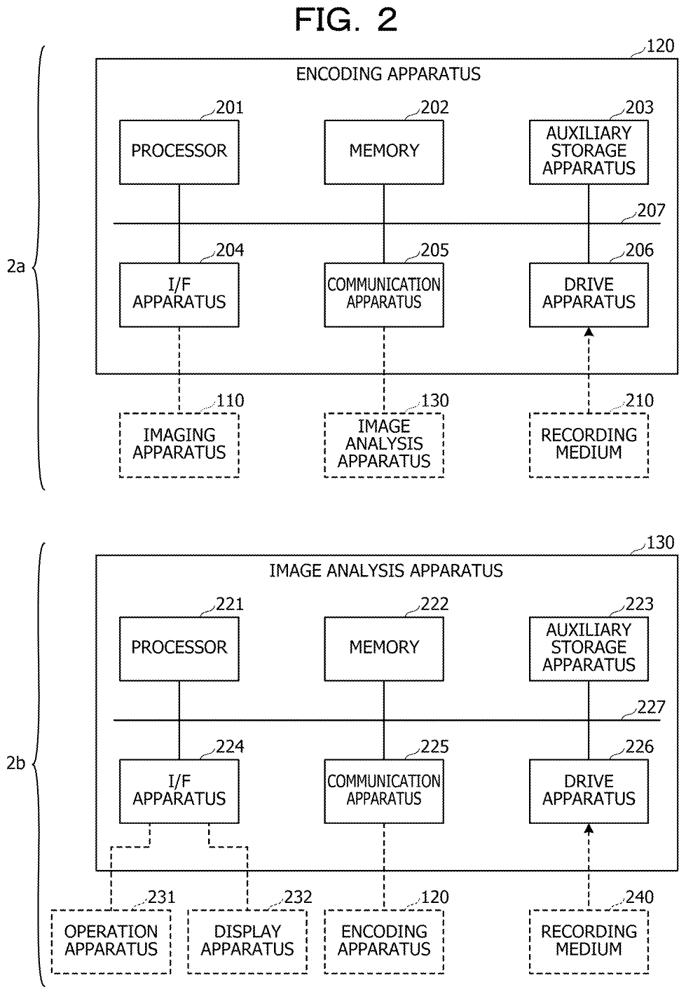

Next, hardware configurations of the encoding device 120 and the image analysis device 130 will be described. FIG. 2 is a diagram illustrating an example of the hardware configuration of the encoding device and the image analysis device.

2a of FIG. 2 is a diagram illustrating an example of the hardware configuration of the encoding apparatus. The encoding apparatus 120 includes a processor 201, a memory 202, an auxiliary storage apparatus 203, an interface (I/F) apparatus 204, a communication apparatus 205, and a drive apparatus 206. Note that the hardware components of the encoding apparatus 120 are coupled to each other via a bus 207.

The processor 201 includes various computing devices such as a central processing unit (CPU) and a graphics processing unit (GPU). The processor 201 reads various programs (for example, an encoding program or the like) onto the memory 202 and executes the programs.

The memory 202 includes a main storage device such as a Read Only Memory (ROM) and a Random Access Memory (RAM). The processor 201 and the memory 202 form a so-called computer, and the processor 201 executes the various programs read in the memory 202, whereby the computer realizes various functions.

The auxiliary storage apparatus 203 stores the various programs and various data used when the various programs are executed by the processor 201.

The I/F apparatus 204 is a coupling device that couples the imaging apparatus 110, which is an example of an external apparatus, and the encoding apparatus 120.

The communication apparatus 205 is a communication device for communicating with the image analysis apparatus 130 via a network.

The drive apparatus 206 is a device for setting the recording medium 210. The recording medium 210 here includes a medium for optically, electrically, or magnetically recording information, such as a CD-ROM, a flexible disk, or a magneto-optical disk. Further, the recording medium 210 may include a semiconductor memory or the like that electrically records information, such as a ROM or a flash memory.

The various programs installed in the auxiliary storage apparatus 203 are installed by, for example, setting the recording medium 210 which is distributed in the drive apparatus 206 and reading the various programs recorded in the recording medium 210 by the drive apparatus 206. Alternatively, the various programs installed in the auxiliary storage apparatus 203 may be installed by being downloaded from the network via the communication apparatus 205.

On the other hand, 2b of FIG. 2 is a diagram illustrating an example of the hardware configuration of the image analysis apparatus 130. Note that the hardware configuration of the image analysis apparatus 130 is substantially the same as the hardware configuration of the encoding apparatus 120, and therefore, the difference from the encoding apparatus 120 will be mainly described here.

For example, the processor 221 reads out the image analysis program or the like onto the memory 222 and executes the image analysis program or the like.

The I/F apparatus 224 receives an operation on the image analysis apparatus 130 via the operation apparatus 231. Further, the I/F apparatus 224 outputs a result of a process by the image analysis apparatus 130 and displays the result via the display apparatus 232. Further, the communication apparatus 225 communicates with the encoding apparatus 120 via the network.

### <Specific Example of Compression Rate Control Process>

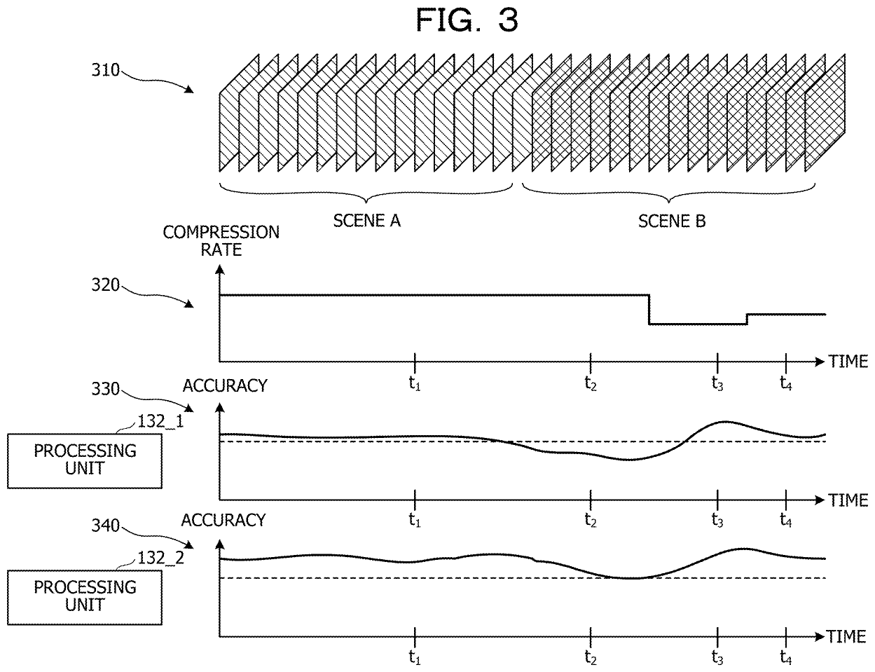

Next, a specific example of the compression rate control process executed by the respective units (the accuracy monitoring unit 134, the compression rate map generation unit 135, and the compression rate setting unit 122) surrounded by the dashed-dotted line in FIG. 1 in the image processing system 100 will be described. FIG. 3 is a diagram illustrating the specific example of the compression rate control process. Note that in the example of FIG. 3, for the sake of simplicity, two processing units (processing unit 132_1 and processing unit 132_2) are provided.

In FIG. 3, reference numeral 310 denotes image data of each frame included in the moving image data. In the example of FIG. 3, it is illustrated that a situation around an imaging position has changed from “scene A” to “scene B” with a passage of time.

Further, in FIG. 3, reference numeral 320 denotes the compression rate of an entire region at each time, and a horizontal axis and a vertical axis denote a time and a compression rate, respectively. According to the example of

FIG. 3, the compression rate map generation unit 135 generates the compression rate map including a new compression rate twice in response to a change in the situation around the imaging position.

Further, in FIG. 3, reference numeral 330 denotes an accuracy of a result of a process performed on the decoded data by the processing unit 132_1, and the horizontal axis and the vertical axis denote the time and the accuracy, respectively. Further, a dotted line indicates an allowable accuracy.

According to the example of reference numeral 330 of FIG. 3, the result of the process by the processing unit 132_1 is equal to or higher than the allowable accuracy at time t₁, but is equal to or lower than the allowable accuracy at time t₂ after the situation around the imaging position changes from “scene A” to “scene B”. Further, the result of the process by the processing unit 132_1 greatly exceeds the allowable accuracy at time t₃ after the compression rate map including the new compression rate is set for the first time. Further, the result of the process by the processing unit 132_1 is close to the allowable accuracy at time t₄ after the compression rate map including the new compression rate is set for the second time.

Further, in FIG. 3, reference numeral 340 indicates the accuracy of the result of the process performed on the decoded data by the processing unit 132_2, and the horizontal axis indicates the time and the vertical axis indicates the accuracy. Further, the dotted line indicates the allowable accuracy.

According to the example of reference numeral 340 of FIG. 3, the result of the process by the processing unit 132_2 is equal to or higher than the allowable accuracy at the time t₁ and the time t₂, but is close to the allowable accuracy between the time t₂ and the time t₃ after the situation around the imaging position changes from “scene A” to “scene B”. Further, the result of the process by the processing unit 132_2 greatly exceeds the allowable accuracy at the time t₃ after the compression rate map including the new compression rate is set for the first time. Further, the result of the process by the processing unit 132_2 is close to the allowable accuracy at the time t₄ after the compression rate map including the new compression rate is set for the second time.

Here, the compression rate control processing will be described with reference to reference numerals 310, 330, and 340. While “scene A” continues, a default compression rate is set in the encoding unit 121, and both the result of the process by the processing unit 132_1 and the result of the process by the processing unit 132_2 exceed the allowable accuracy.

On the other hand, the situation around the imaging position changes from “scene A” to “scene B”, whereby the default compression rate becomes inappropriate and the accuracy of the result of the process by the processing unit 132_1 and the accuracy of the result of the process by the processing unit 132_2 decrease.

As indicated by reference numeral 330, when the result of the process by the processing unit 132_1 becomes equal to or less than the allowable accuracy, as indicated by reference numeral 320, the accuracy monitoring unit 134 determines a compression rate lower than the current compression rate as a new compression rate. Further, the compression ratio map generation unit 135 generates a compression rate map in which the determined new compression rate is stored in the entire region of the image data, and the compression rate setting unit 122 sets the generated compression rate map in the encoding unit 121. As a result, the image quality of the decoded data is improved, and both the result of the process by the processing unit 132_1 and the result of the process by the processing unit 132_2 greatly exceed the allowable accuracy.

As indicated by reference numerals 330 and 340, the results of the process by the processing unit 132_1 and the processing unit 132_2 greatly exceed the allowable accuracy, and thus, as indicated by reference numeral 320, the accuracy monitoring unit 134 determines a compression rate higher than the current compression rate as a new compression rate. Further, the compression rate map generation unit 135 generates a compression rate map in which the determined new compression rate is stored in the entire region of the image data, and the compression rate setting unit 122 sets the generated compression ratio map in the encoding unit 121. Thus, both the result of the process by the processing unit 132_1 and the result of the process by the processing unit 132_2 approach the allowable accuracy.

In this way, by monitoring the accuracy of the result of the process by each processing unit and appropriately controlling the compression rate of each region according to the monitored accuracy, the predetermined accuracy may be obtained for the result of any process by the AI. For example, according to the present embodiment, it is possible to generate decoded data that may be used in the plurality of processes by the AI.

Note that the accuracy of the result of the process by each processing unit may be calculated by any method. For example, when the processing unit performs a process for identifying an attribute of a target object, an accuracy of the identified attribute or a transition of the accuracy may be calculated as the accuracy of the result of the process.

In addition, in a case where the processing unit performs a process of detecting the target object, for example, a detection frequency of the target object in a plurality of pieces of decoded data or a transition of the detection frequency may be calculated as the accuracy of the result of the process.

In addition, when the processing unit performs a process of measuring a distance to the target object, for example, a fluctuation of the distance up to the target object or a transition of the fluctuation in each of the plurality of pieces of decoded data may be calculated as the accuracy of the result of the process.

Note that in the example of FIG. 3, the accuracy monitoring unit 134 monitors the accuracy of the results of the processes by the processing unit 132_1 and the processing unit 132_2 for all the regions of the image data. Further, the compression rate map generation unit 135 generates the compression rate map by storing the determined new compression rate in the entire region of the image data.

However, the method of generating the compression rate map is not limited to this. For example, the accuracy monitoring unit 134 may monitor the accuracy of the result of the process by the processing unit 132_1 and the processing unit 132_2 for each set granularity of the compression rate (for example, an encoding block in encoding of the moving image) which is configurable by the encoding unit 121.

Thus, the compression rate map generation unit 135 may generate a compression rate map in which the compression rate determined for each set granularity is stored. In this case, a compression ratio map is generated in which the compression rate determined based on the accuracy of the result of the process by each of the processing unit 132_1 and the processing unit 132_2 is stored in each region for each set granularity in the image data.

Such a generation method is effective, for example, when the accuracy of the result of the process by each of the processing unit 132_1, the processing unit 132_2, and the processing unit 132_n varies depending on the region in the image data or a type of the target object in the image data. Alternatively, the generation method is effective in a case where pieces of position information of target objects whose attributes are identified by the processing unit 132_1, the processing unit 132_2, and the processing unit 132-n executed in parallel are integrated and different compression rates are stored in regions for each set granularity or the like.

### <Flow of Compression Rate Control Process>

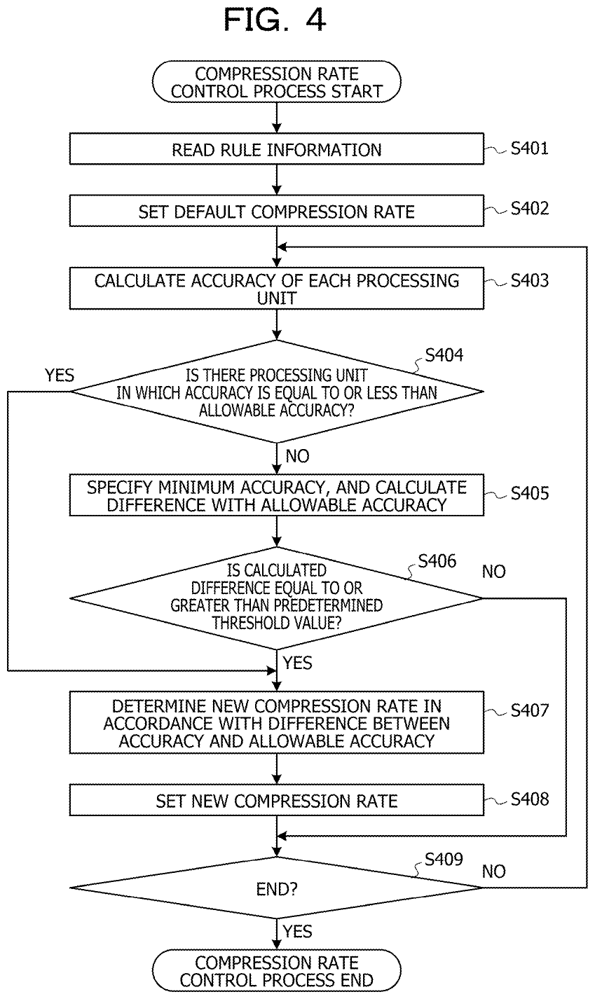

Next, the flow of the compression rate control process will be described. FIG. 4 is a first flowchart illustrating the flow of the compression rate control process.

In step S401, the accuracy monitoring unit 134 reads the rule information 136 defined in advance.

In step S402, the compression rate map generation unit 135 generates a compression rate map in which the default compression rate is stored in the entire area of the image data, and the compression rate setting unit 122 sets the generated compression rate map in the encoding unit 121.

In step S403, the accuracy monitoring unit 134 acquires the results of the processes performed by the processing units 132_1 to 132_n and calculates the accuracy of each of the results of the processes.

In step S404, the accuracy monitoring unit 134 determines whether or not there is a processing unit in which the result of the process is equal to or less than the allowable accuracy. In step S404, when it is determined that there is a processing unit in which the processing result is equal to or less than the allowable accuracy (in the case of YES in step S404), the process proceeds to step S407.

In this case, in step S407, the accuracy monitoring unit 134 determines a new compression rate in accordance with a difference between the accuracy of the result of the process and the allowable accuracy so that the result of the process (all the results of the processes when the result of the process being equal to or less than the allowable accuracy is multiple) becomes equal to or more than the allowable accuracy.

On the other hand, in step S404, in a case where it is determined that there is no processing unit in which the result of the process is equal to or less than the allowable accuracy (in a case of NO in step S404), the process proceeds to step S405.

In step S405, the accuracy monitoring unit 134 specifies a minimum accuracy among the accuracies of the results of the processes by each of the processing units 132_1 to 132_n, and calculates the difference between the specified minimum accuracy and the allowable accuracy.

In step S406, the accuracy monitoring unit 134 determines whether the calculated difference is equal to or larger than a predetermined threshold value (for example, whether the specified minimum accuracy exceeds the allowable accuracy by the predetermined threshold value or more). If it is determined in step S406 that the difference is less than the predetermined threshold value (NO in step S406), the process proceeds to step S409.

On the other hand, when it is determined in step S406 that the difference is equal to or greater than the predetermined threshold value (YES in step S406), the process proceeds to step S407.

In this case, in step S407, the accuracy monitoring unit 134 determines the new compression rate in accordance with the difference between the minimum accuracy and the allowable accuracy so that the minimum accuracy approaches the allowable accuracy.

In step S408, the compression rate map generation unit 135 generates a compression rate map in which the determined new compression rate is stored in the entire region of the image data, and the compression rate setting unit 122 sets the generated compression rate map in the encoding unit 121.

In step S409, the accuracy monitoring unit 134 determines whether or not to end the compression rate control process. When it is determined in step S409 that the compression rate control process is to be continued (NO in step S409), the process returns to step S403.

On the other hand, when it is determined in step S409 that the compression rate control process is to be ended (YES in step S409), the compression rate control process is ended.

### <Control Result of Compression Rate>

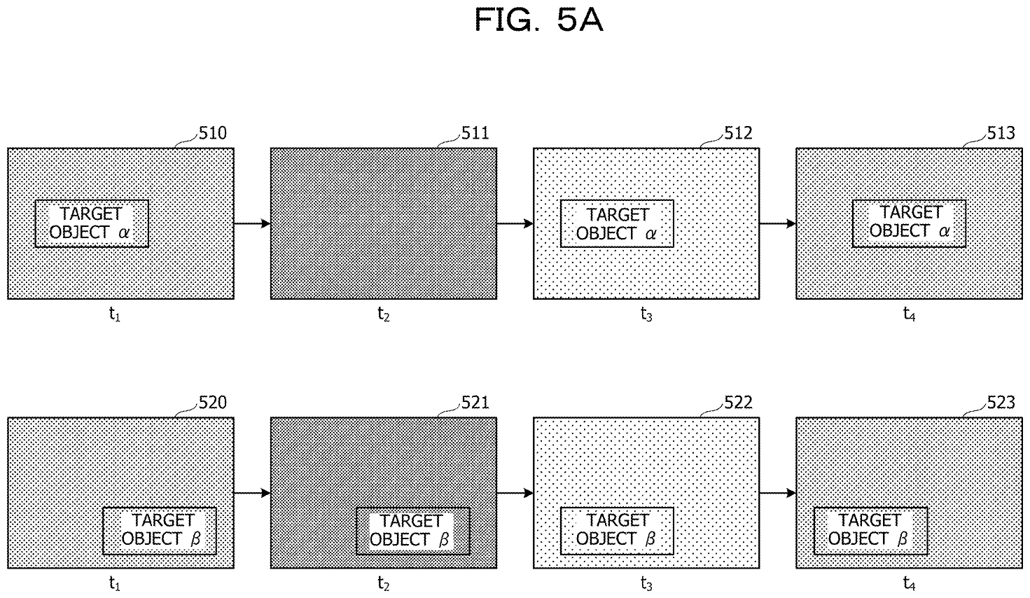

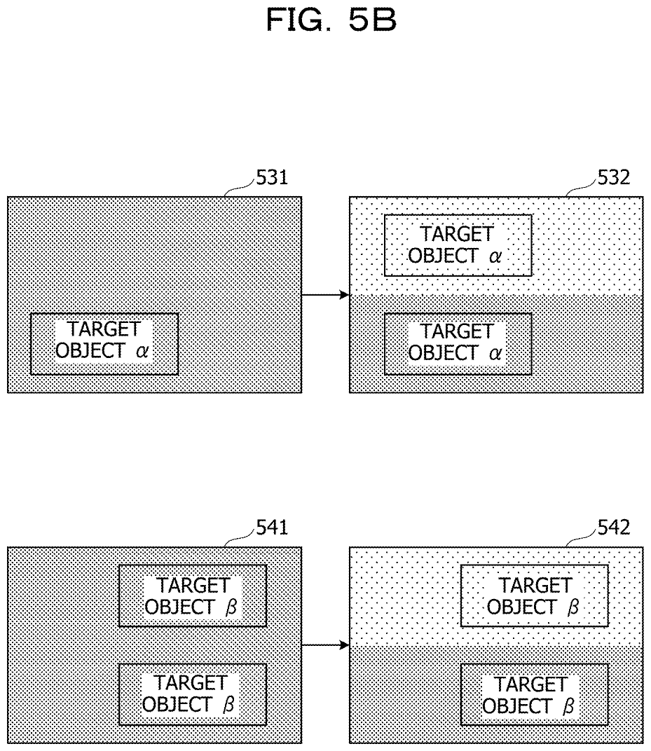

Next, the control result of the compression rate by the compression rate control process (FIG. 4) will be described. FIG. 5A is a first diagram illustrating an example of the control result of the compression rate. In FIG. 5A, decoded data 510 to 513 indicate decoded data processed by the processing unit 132_1 at times t₁ to t₄ in FIG. 3, respectively. Further, in FIG. 5A, decoded data 520 to 523 indicate decoded data processed by the processing unit 132_2 at times t₁ to t₄ in FIG. 3, respectively.

Note that, in the decoded data 510 to 513 and 520 to 523, a difference in a density of hatching indicates a difference in the image quality of the decoded data due to the difference in the compression rate. For example, it is indicated that the lighter the hatching is, the lower the compression rate is and the higher the image quality of the decoded data is and that the darker the hatching is, the higher the compression rate is and the lower the image quality of the decoded data is.

The example of FIG. 5A indicates that the processing unit 132_1 and the processing unit 132_2 can may identify the attribute of the target object α and the attribute of the target object β, respectively, at time t₁ before the situation around the imaging position changes.

Further, the example of FIG. 5A indicates that the processing unit 132_1 may not identify the attribute of the target object α at time t₂ due to a change in the situation around the imaging position.

Further, the example of FIG. 5A indicates that the compression rate is appropriately controlled in response to the processing unit 132_1 becoming unable to identify the attribute of the target object α, and thus the processing unit 132_1 becomes able to identify the attribute of the target object α again at time t₃ and time t₄.

On the other hand, FIG. 5B is a second diagram illustrating an example of the control result of the compression rate. The example of FIG. 5B indicates a case where the accuracy is monitored for each set granularity of the compression rate, and here, for the sake of simplicity of description, a case where the accuracy is monitored in each of two regions is indicated.

As illustrated in FIG. 5B, the processing unit 132_1 identifies only the attribute of the target object α located below by processing, by the processing unit 132_1, the decoded image 531. Further, the decoded data 541 is processed by the processing unit 132_2, and thus the processing unit 132_2 identifies both the attribute of the target object β located below and the attribute of the target object β located above.

In this way, in an upper region, when the result of the process by the processing unit 132_1 becomes equal to or less than the allowable accuracy, the compression rate of the upper region is appropriately controlled.

The example of FIG. 5B indicates that the processing unit 132_1 may identify both the attribute of the target object α located below and the attribute of the target object α located above by processing, by the processing unit 132_1, the decoded image 532 after the compression rate of the upper region is appropriately controlled.

Further, the example of FIG. 5B1 indicates that the processor 132_2 may identify both the attribute of the target object β located below and the attribute of the target object β located above by processing, by the processor 132_2, the decoded image 542 after the compression rate of the upper region is appropriately controlled.

As is clear from the above description, in the image processing system 100 according to the first embodiment, a plurality of processes by the AI are performed in parallel on decoded data generated by decoding encoded image data. Further, the image processing system 100 according to the first embodiment determines a compression rate for encoding the image data so that the result of any of the plurality of processes by the AI may obtain the allowable accuracy, and encodes the image data with the determined compression ratio.

As described above, in the image processing system 100 according to the first embodiment, the accuracy of the results of the plurality of processes by the AI is monitored, and the compression rate of each region is appropriately controlled according to the monitored accuracy. Thus, according to the image processing system 100 of the first embodiment, even when the image quality of the decoded data is degraded due to a change in the situation around the imaging position, the image quality is improved by changing the compression rate, and thus the acceptable accuracy may be obtained as the result of any of the processes by the AI.

For example, according to the first embodiment, it is possible to generate decoded data that may be used in the plurality of processes by the AI.

### Second Embodiment

In the first embodiment described above, the case where the plurality of processes by the AI are performed in parallel has been described. In contrast, in the second embodiment, a case where the plurality of processes by the AI are sequentially performed will be described.

When the plurality of processes by the AI are sequentially performed, in each process (for example, the (x+1)-th process), the result of the process (for example, the x-th process) performed earlier is used. Therefore, when decoded data having an image quality different from that of the process performed earlier is required, the compression rate needs to be switched. Therefore, the image processing system according to the second embodiment is provided with a function of sequentially switching the compression rate. In order to realize this function, the image processing system according to the second embodiment perform: a specifying phase for specifying a switching method when the compression rate is sequentially switched; and an encoding phase of performing an encoding while sequentially switching the compression rate in accordance with the specified switching method. Therefore, in the second embodiment, the specifying phase and the encoding phase will be separately described below. However, the description will be made focusing on the differences from the first embodiment.

### <System Configuration of Image Processing System (Specifying Phase)>

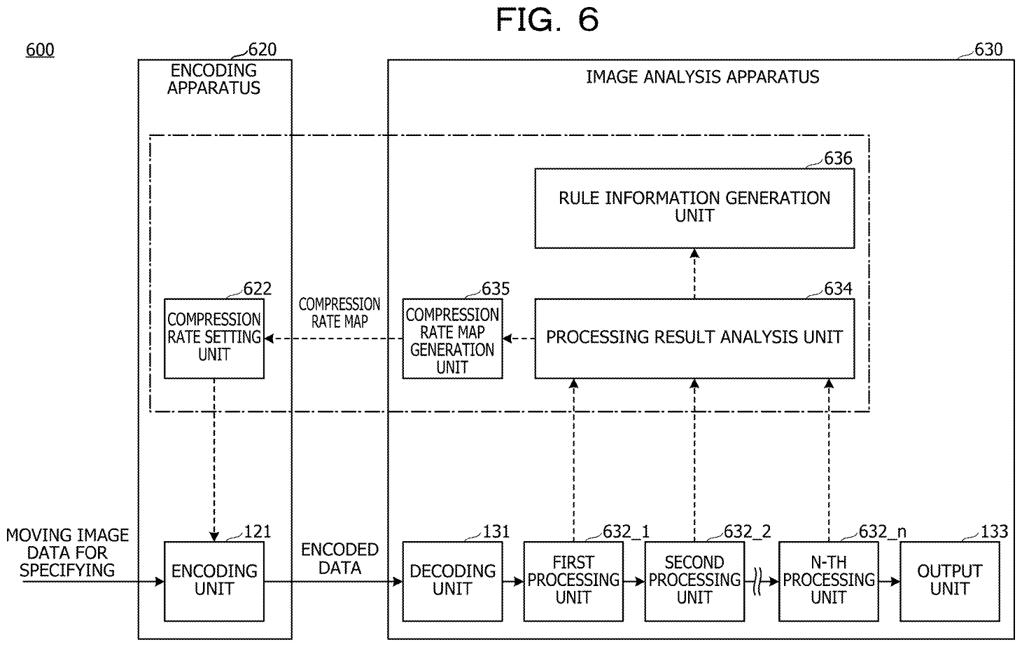

First, a system configuration of an image processing system in the specifying phase including an encoding apparatus and an image analysis apparatus according to the second embodiment will be described. FIG. 6 is a diagram illustrating an example of the system configuration of the image processing system in the specific phase. As illustrated in FIG. 6, the image processing system 600 in the specific phase includes an encoding apparatus 620 and an image analysis apparatus 630.

An encoding program is installed in the encoding apparatus 620, and the encoding program is executed, whereby the encoding apparatus 620 functions as the encoding unit 121 and the compression rate setting unit 622.

The encoding unit 121 of these units has the same function as the encoding unit 121 described with reference to FIG. 1 in the first embodiment described above, and, therefore, a description thereof will be omitted. However, in the specifying phase, the encoding unit 121 encodes the image data of each frame included in the moving image data for specifying to generate encoded data.

Every time the compression rate setting unit 622 acquires the compression rate map generated by the image analysis apparatus 630, the compression rate setting unit 622 sets the acquired compression rate map in the encoding unit 121. In the specifying phase, the compression rate setting unit 622 sets a compression rate map in which the compression rate is lowered in stages in the encoding unit 121 in order to search for a compression rate capable of providing image quality required by each of the plurality of processes by the AI.

An image analysis program is installed in the image analysis apparatus 630. The image analysis apparatus 630 functions as the decoding unit 131, the first processing unit 632_1, the second processing unit 632_2, and an n-th processing unit 632-n, and the output unit 133 by executing the image analysis program. Further, the image analysis apparatus 630 functions as a processing result analysis unit 634, a compression rate map generation unit 635, and a rule information generation unit 636.

The decoding unit 131 and the output unit 133 of these units have been described in the first embodiment described above with reference to FIG. 1, and a description thereof will be omitted.

Each of the first processing unit 632_1, the second processing unit 632_2, and the n-th processing unit 632_n sequentially performs the process by the AI on the decoded data. The processing unit that sequentially performs the process by the AI indicates, for example, a processing unit including: a process that the first processing unit 632_1 performs the object detection process for detecting a predetermined target object from the decoded data; a process that the second processing unit 632_2 performs the distance measurement process for measuring a distance up to the detected target object; and a process that the third processing unit 632_3 performs a situation determination process for determining the situation of the target object based on the measured distance.

In addition, the first processing unit 632_1, the second processing unit 632_2, and the n-th processing unit 632-n process each piece of the decoded data generated by decoding, by the decoding unit 131, each piece of encoded data encoded by lowering the compression rate in stages in the specifying phase.

Further, the first processing unit 632_1, the second processing unit 632_2, and the n-th processing unit 632-n notify the processing result analysis unit 634 of the result of the process performed on each piece of the decoded data in the specifying phase.

The processing result analysis unit 634 acquires the result of the process performed on each piece of the decoded data from each of the first processing unit 632_1, the second processing unit 632_2, and the n-th processing unit 632_n in the specifying phase. In addition, the processing result analysis unit 634 analyzes the acquired result of the process in the specifying phase, searches for a compression rate at which the image quality necessary for each processing unit to output an appropriate result of the process may be provided to each processing unit, and specifies a switching compression rate.

The compression rate map generation unit 635 sequentially generates a compression rate map in which the compression rate lowered in stages is stored in all regions in the specifying phase, and transmits the compression rate map to the encoding apparatus 620.

The rule information generation unit 636 specifies a switching condition for switching the compression rate and a region to be switched based on the switching compression rate of each processing unit searched by the processing result analysis unit 634. Then, the rule information generation unit 636 generates rule information that defines a rule for determining a compression rate when the process by the AI is sequentially performed on the decoded data.

For example, the rule information generated by the rule information generation unit 636 includes, in addition to a decision rule defined in the rule information 136 described in the first embodiment, a decision rule which defines a condition for switching the compression rate; an area in which the compression rate is switched when the condition is satisfied; and a compression rate to be switched (the switching compression rate) when the condition is satisfied.

As described above, in the image processing system 600 in the specifying phase, each unit surrounded by the dashed-dotted line performs the rule information generation process for generating the rule information.

### <Result of Process by Each Processing Unit (Specifying Phase)>

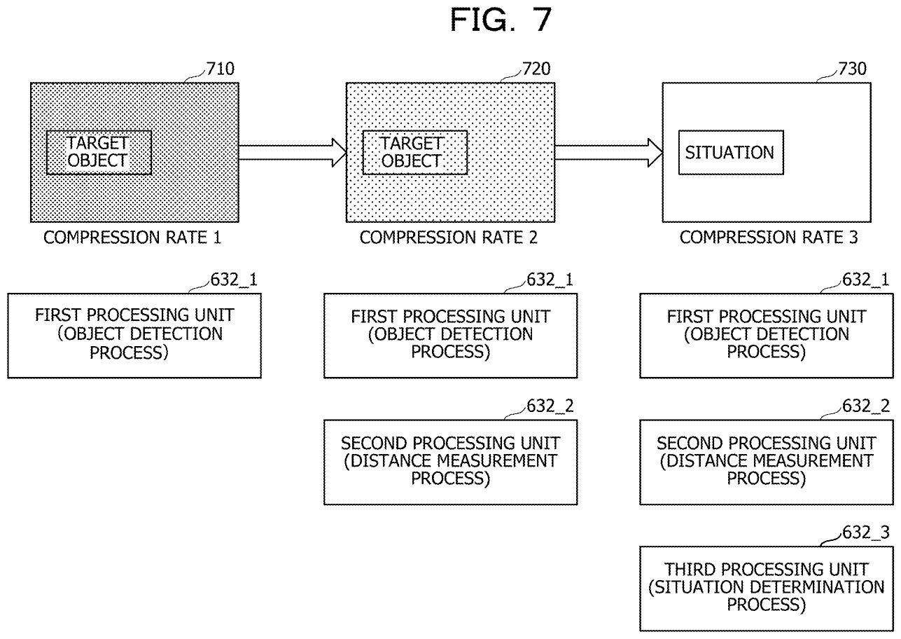

Next, the result of the process by each processing unit in the specifying phase will be described. FIG. 7 is a diagram illustrating an example of a result of process performed by each processing unit;

In FIG. 7, decoded data 710 to 730 indicate decoded data generated by encoding image data of each frame included in specifying moving image data by lowering in stages the compression rate and decoding the encoded image data.

Further, in FIG. 7, the decoded data 710 indicates decoded data in which the target object is detected by the object detection process by the first processing unit 632_1. Further, the decoded data 720 indicates decoded data in which the target object is detected by the first processing unit 632_1 and the distance up to the target object is measured by the distance measurement process by the second processing unit 632_2. Further, the decoded data 730 indicates decoded data in which the target object is detected by the first processing unit 632_1, the distance up to the target object is measured by the second processing unit 632_2, and the situation of the target object is determined by the situation determination process by the third processing unit 632_3.

As illustrated in FIG. 7, by lowering the compression rate to a compression rate 1, the first processing unit 632_1 may appropriately detect the target object from the decoded data 710. Thus, the processing result analyzing unit 634 may specify the compression rate 1 as the switching compression rate of the first processing unit 632_1.

Further, as illustrated in FIG. 7, by lowering the compression rate to a compression ratio 2, the second processing unit 632_2 may appropriately measure the distances up to the object in the region where the target object of the decoded image 720 is detected. Thus, the processing result analyzing unit 634 may specify the compression rate 2 as the switching compression rate of the second processing unit 632_2.

Further, as illustrated in FIG. 7, by lowering the compression rate to a compression rate 3, the third processing unit 632_3 may appropriately determine the situation of the target object based on the distance up to the target object in the region where the target object of the decoded data 730 is detected. Thus, the processing result analysis unit 634 may specify the compression rate 3 as the switching compression rate of the third processing unit 632_3.

### <Details of Rule Information>

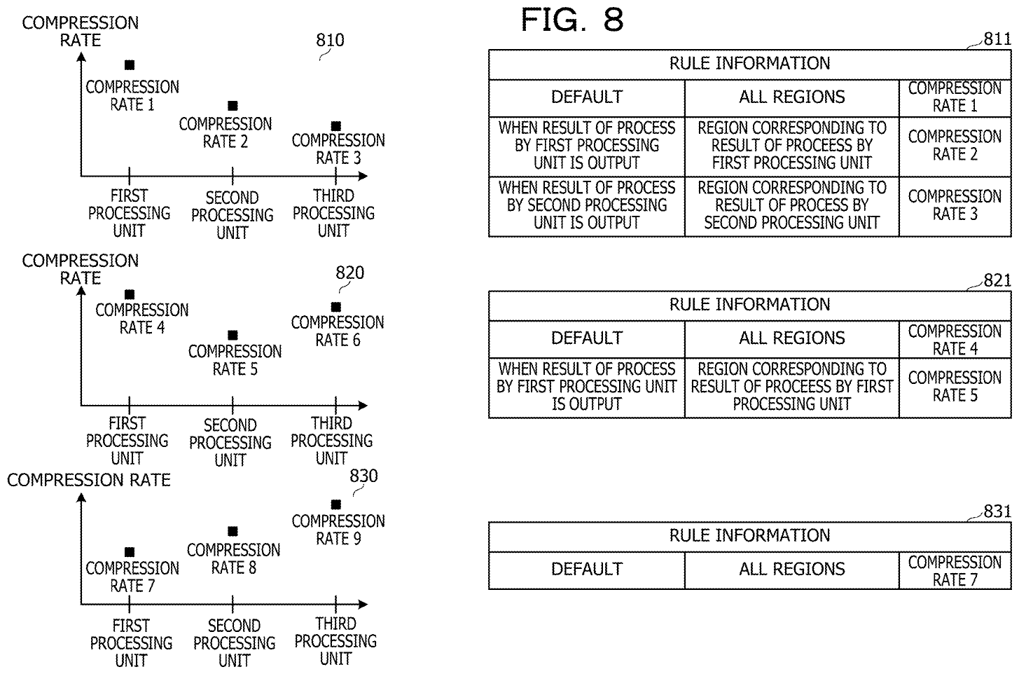

Next, the rule information generated in the specifying phase will be described in detail. FIG. 8 is a diagram illustrating an example of the rule information; Here, for the sake of simplicity of description, a case where the image analysis apparatus 130 includes the first processing unit 632_1 to the third processing unit 632_3 will be described.

Reference numeral 810 from among reference numerals indicates that:

image quality required when the first processing unit 632_1 performs a process, image quality required when the second processing unit 632_2 performs a process and image quality required when the third processing unit 632_3 performs a process are different from each other, a relationship of (the image quality required when first processing unit 632_1 performs the process)<(the image quality required when second processing unit 632_2 performs the process)<(the image quality required when third processing unit 632_3 performs the process) is established and the switching compression rate is specified as a compression rate 1>a compression rate 2>a compression rate 3.

In this case, rule information 811 includes, in addition to the decision rule defined in the rule information 136 described in the first embodiment, a decision rule which defines that the compression rate 1 is set for all regions of the image data as default; the compression rate of the region corresponding to the result of the process by the first processing unit 632_1 in the image data is switched to the compression rate 2 on condition that the result of the process by the first processing unit 632_1 is output; and the compression rate of the region corresponding to the result of the process by the second processing unit 632_2 in the image data is switched to the compression rate 3 on condition that the result of the process by the second processing unit 632_2 is output.

Further, reference numeral 820 indicates that the image quality required when the first processing unit 632_1 performs the process, the image quality required when the second processing unit 632_2 performs the process and the image quality required when the third processing unit 632_3 performs the process are different from each other, a relationship of (the image quality required when first processing unit 632_1 performs the process)<(the image quality required when second processing unit 632_2 performs the process)>(the image quality required when third processing unit 632_3 performs the process) is established and the switching compression rate is specified as a compression rate 4>a compression rate 5<a compression rate 6.

In this case, rule information 821 includes, in addition to the decision rule defined in the rule information 136 described in the first embodiment described above, a decision rule which defines the compression rate 4 is set for all regions of the image data as the default; and the compression rate of the region corresponding to the result of the process by the first processing unit 632_1 in the image data is switched to the compression rate 5 on condition that the result of the process by the first processing unit 632_1 is output.

Further, reference numeral 830 indicates that the image quality required when the first processing unit 632_1 performs the process, the image quality required when the second processing unit 632_2 performs the process and the image quality required when the third processing unit 632_3 performs the process are different from each other, a relationship of (the image quality required when first processing unit 632_1 performs the process)>(the image quality required when second processing unit 632_2 performs the process)>(the image quality required when third processing unit 632_3 performs the process) is established and the switching compression rate is specified as a compression rate 7<a compression rate 8<a compression rate 9.

In this case, the rule information 831 includes, in addition to the decision rule defined in the rule information 136 described in the first embodiment described above, a decision rule which defines that the compression rate 7 is set for the entire region of the image data as the default.

### <Flow of Rule Information Generation Process>

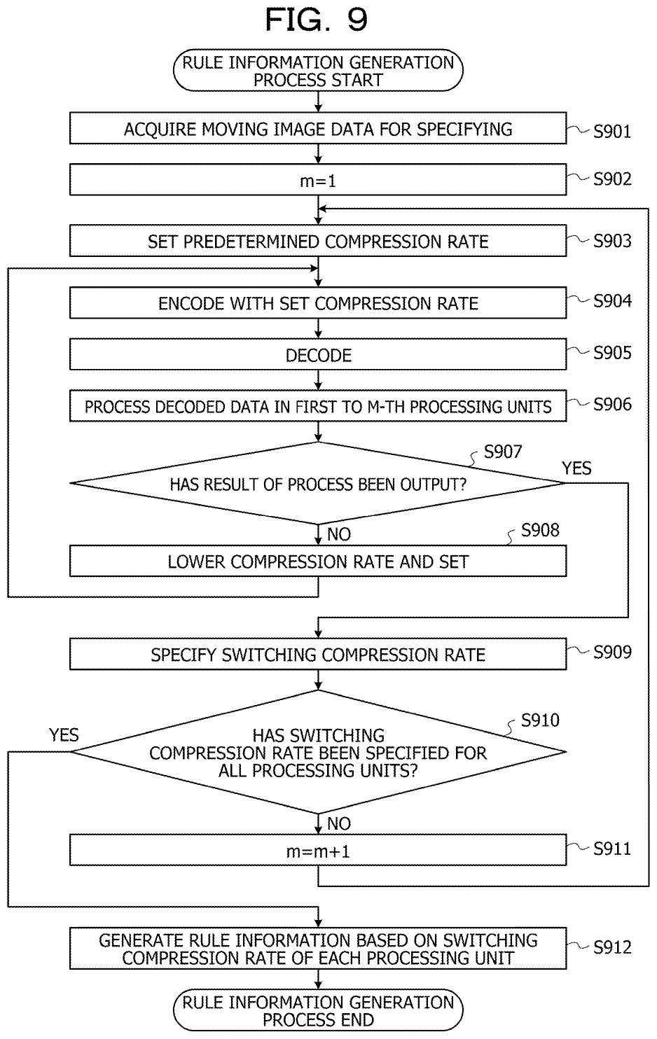

Next, a flow of the rule information generation process by the image processing system 600 in the specifying phase will be described. FIG. 9 is a flowchart illustrating the flow of the rule information generation process.

In step S901, the encoding apparatus 120 acquires the moving image data for specifying.

In step S902, the processing result analysis unit 634 of the image analysis apparatus 630 sets “1” to a counter m indicating the process order of each processing unit.

In step S903, the compression rate map generation unit 635 of the image analysis apparatus 630 transmits a compression rate map in which a predetermined compression rate is stored in the entire region of the image data to the encoding apparatus 120. Further, the compression rate setting unit 622 of the encoding apparatus 120 sets the compression rate map in the encoding unit 121.

In step S904, the encoding unit 121 of the encoding apparatus 120 encodes the image data included in the moving image data for specifying with the set compression rate map to generate encoded data, and transmits the encoded data to the image analysis apparatus 130.

In step S905, the decoding unit 131 of the image analysis apparatus 130 decodes the encoded data to generate decoded data.

In step S906, the first to m-th processing units of the image analysis apparatus 130 process the decoded data.

In step S907, the processing result analysis unit 634 of the image analysis apparatus 130 determines whether or not an appropriate result of the process is output by the m-th processing unit. When it is determined in step S907 that the appropriate result of the process has not been output (NO in step S907), the process proceeds to step S908.

In step S908, the compression rate map generation unit 635 of the image analysis apparatus 130 generates a compression rate map in which the compression rate lowered by a predetermined step width in the entire region of the image data is stored, and transmits the compression rate map to the encoding apparatus 120. Further, the compression rate setting unit 622 of the encoding apparatus 120 sets the compression rate map in the encoding unit 121. Thereafter, the process returns to step S904.

On the other hand, when it is determined in step S907 that the appropriate result of the process has been output (YES in step S907), the process proceeds to step S909.

In step S909, the processing result analysis unit 634 of the image analysis apparatus 130 specifies the compression rate when the appropriate result of the process is output as the switching compression rate of the m-th processing unit.

In step S910, the processing result analysis unit 634 of the image analysis apparatus 130 determines whether or not the switching compression rate has been specified for all the processing units. When it is determined in step S910 that there is a processing unit for which the switching compression rate has not been specified (in the case of NO in step S910), the process proceeds to step S911.

In step S911, the processing result analysis unit 634 of the image analysis apparatus 630 increments the counter m indicating the process order, and the process returns to step S903.

On the other hand, in a case where it is determined that the switching compression rate has been specified for all the processing units in step S910 (in the case of YES in step S910), the process proceeds to step S912.

In step S912, the rule information generation unit 636 of the image analysis apparatus 630 generates rule information based on the switching compression rate of each processing units, and ends the rule information generation process.

### <System Configuration of Image Processing System (Encoding Phase)>

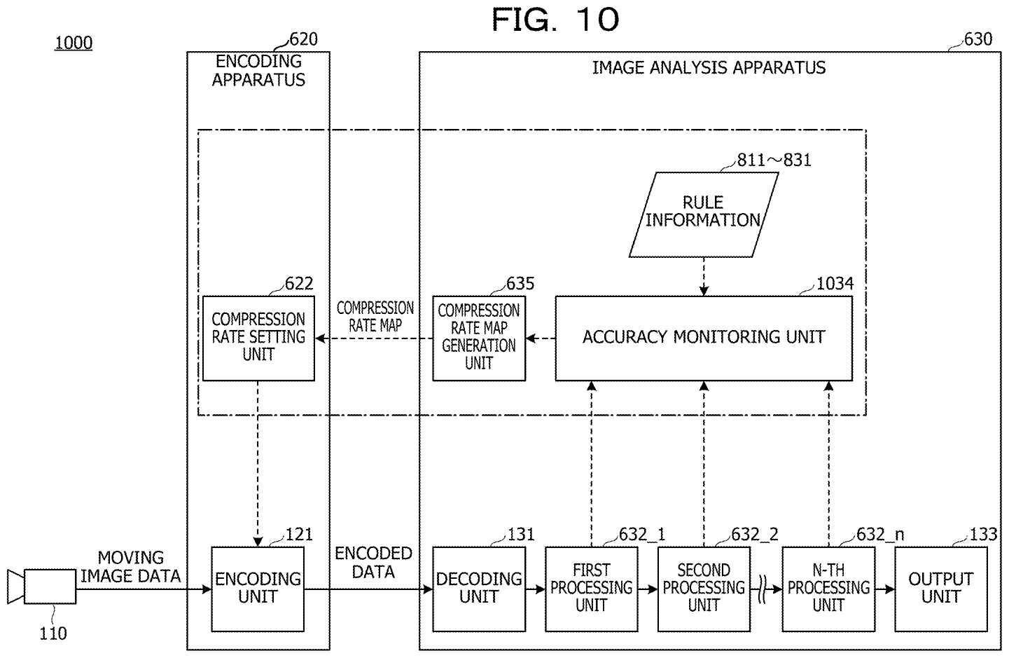

Next, a system configuration of an image processing system in an encoding phase including an encoding apparatus and an image analysis apparatus according to the second embodiment will be described. FIG. 10 is a diagram illustrating an example of a system configuration of the image processing system in the encoding phase. As illustrated in FIG. 10, the image processing system 1000 includes an imaging apparatus 110, an encoding apparatus 620, and an image analysis apparatus 630.

An encoding program is installed in the encoding apparatus 620, and the encoding program is executed, whereby the encoding apparatus 620 functions as the encoding unit 121 and the compression rate setting unit 622.

The encoding unit 121 of these units has the same function as the encoding unit 121 described with reference to FIG. 1 in the first embodiment, and the description thereof will be omitted.

Every time the compression rate setting unit 622 acquires the compression rate map generated by the image analysis apparatus 630, the compression rate setting unit 622 sets the acquired compression rate map in the encoding unit 121. Note that in the encoding phase, the compression rate setting unit 622 acquires any of a compression rate map in which a switching compression rate based on rule information (for example, any of the rule information 811 to 831) is stored in each region or a compression rate map in which a compression rate newly determined for the switching compression rate is stored in each region.

An image analysis program is installed in the image analysis apparatus 630. The image analysis apparatus 630 functions as the decoding unit 131, the first processing unit 632_1, the second processing unit 632_2, and the n-th processing unit 632-n, the output unit 133, an accuracy monitoring unit 1034, and the compression rate map generation unit 635 by executing the image analysis program.

Among these, the decoding unit 131, the first processing unit 632_1, the second processing unit 632_2, the n-th processing unit 632-n, the output unit 133, and the compression rate map generation unit 635 of these units have been already described, and thus the description thereof will be omitted here.

The accuracy monitoring unit 1034 performs an accuracy monitoring process based on the rule information (for example, any of the rule information 811 to 831). As described above, the rule information 811 to 831 includes, in addition to the decision rule defined in the rule information 136 described in the first embodiment, a decision rule which defines a condition for switching the compression rate, an area in which the compression rate is switched when the condition is satisfied and a compression rate to be switched (a switching compression rate) when the condition is satisfied. Therefore, when the first processing unit 632_1 to the n-th processing unit 632_n perform a process on the decoded data, the accuracy monitoring unit 1034 refers to any of the rule information 811 to 831 and determines the switching compression rate based on the result of the process by each processing unit.

Further, the accuracy monitoring unit 1034 monitors whether a predetermined accuracy is obtained for the result of the process by each processing unit. Then, when the accuracy monitoring unit 134 determines that the predetermined accuracy is not obtained for the result of the process by any of the processing units, the accuracy monitoring unit 134 determines a new compression rate so that the predetermined accuracy is obtained.

When the compression rate map generation unit 635 is notified of the switching compression rate by the accuracy monitoring unit 1034, the compression rate map generation unit 104 generates a compression rate map by storing the switching compression rate in a corresponding region. Further, When the compression rate map generation unit 635 is notified of a newly determined compression rate by the accuracy monitoring unit 1034, the compression rate map generation unit 104 generates a compression rate map by storing the newly determined compression rate in the corresponding region. Further, the compression rate map generation unit 635 transmits the generated compression rate map to the encoding apparatus 620 every time the compression rate map is generated.

### <Flow of Compression Rate Control Process>

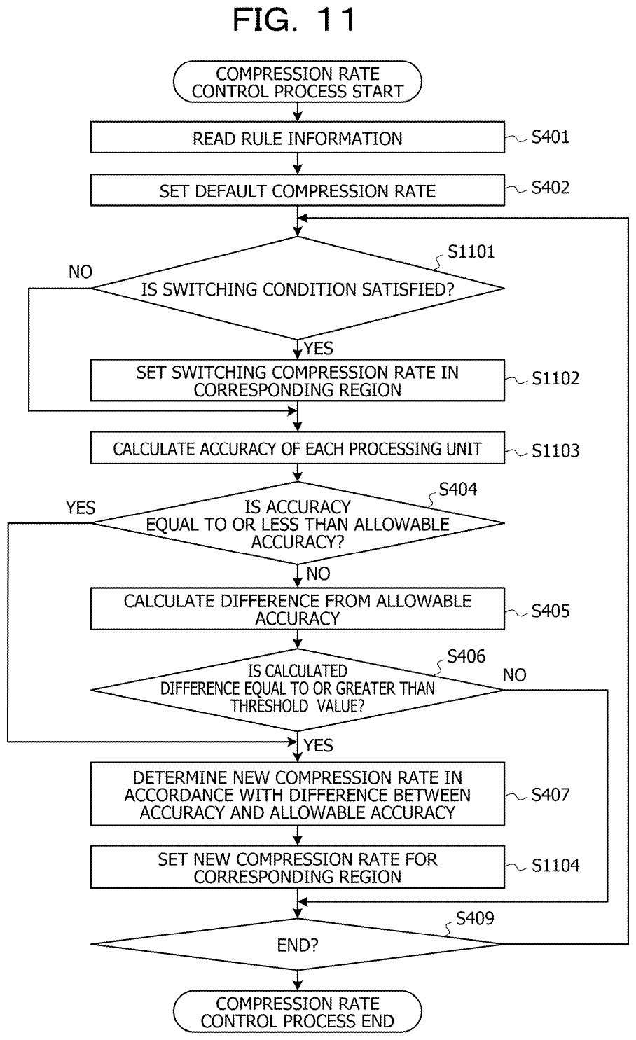

Next, a flow of the compression rate control process in the encoding phase will be described. FIG. 11 is a second flowchart illustrating the flow of the compression rate control process. In the first embodiment, the difference from the compression rate control process described with reference to FIG. 4 is steps S1101 to S1103 and S1104.

In step S1101, the accuracy monitoring unit 1034 determines whether or not the results of the processes by the first processing unit 632_1 to the n-th processing unit 632_n satisfy the switching condition defined in the rule information.

When it is determined in step S1101 that the switching condition is not satisfied (NO in step S1101), the process proceeds to step S1103.

On the other hand, when it is determined in step S1101 that the switching condition is satisfied (YES in step S1101), the process proceeds to step S1102.

In step S1102, the compression rate map generation unit 635 generates the compression rate map by storing the switching compression rate in the corresponding region. Further, the compression rate setting unit 622 sets the generated compression rate map in the encoding unit 121.

In step S1103, the accuracy monitoring unit 1034 acquires the results of the processes performed by the first processing unit 632_1 to the n-th processing unit 632_n, and calculates the accuracy of each of the results of the processes.

In step S1104, the compression rate map generation unit 635 generates a compression rate map by storing the newly determined compression rate in the corresponding region, and the compression rate setting unit 622 sets the generated compression rate map in the encoding unit 121.

### <Compression Rate Switching Result>

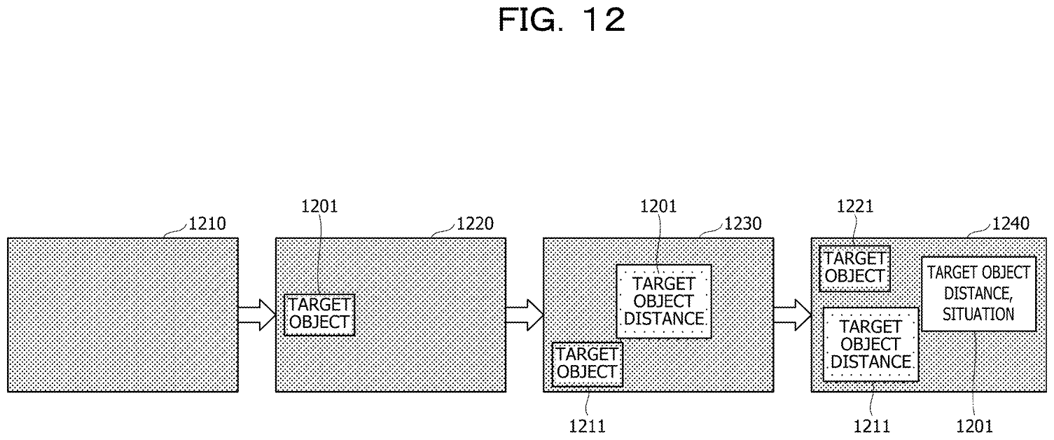

Next, a specific example of the result of switching the compression rate by the compression rate control process (FIG. 11) will be described. FIG. 12 is a diagram illustrating an example of the result of switching the compression rate. In FIG. 12, decoded data 1210 to 1240 indicate decoded data generated by encoding and decoding the image data of each frame included in the moving image data.

Note that in the decoded data 1210 to 1240, a difference in a density of hatching indicates a difference in the image quality of the decoded data due to the difference in the compression rate. For example, it is indicated that the lighter the hatching is, the lower the compression rate is and the higher the image quality of the decoded data is and that the darker the hatching is, the higher the compression rate is and the lower the image quality of the decoded data is.

The example of FIG. 12 illustrates a state in which a plurality of target objects appear with the passage of time. As illustrated in FIG. 12, with respect to the decoded data 1210, the first processing unit 632_1 performs the object detection process on the entire region of the decoded data 1210. At this time, the image data is encoded at the compression ratio 1.

The first processing unit 632_1 performs the object detection process on the entire region of the decoded image data 1220 to detect a target object 1201. At this time, the image data is encoded at the compression ratio 1, but in accordance with the detection of the target object 1201, the compression ratio of the region corresponding to the region where the target object 1201 is detected is switched to the compression ratio 2, which is lower than the compression ratio 1.

The decoded data 1230 is decoded data obtained by decoding encoded data obtained by encoding the region where the target object 1201 is detected in image data, among the image data, at the compression rate 2 and encoding a region other than the region where the target object 1201 is detected in the image region at the compression rate 1.

The first processing unit 632_1 performs the object detection processing on the entire region of the decoded data 1230 to detect the target object 1201 and a target object 1211. In addition, the second processing unit 632_2 performs the distance measurement process on the region where the target object 1201 is detected, and measures the distance up to the target object. In addition, as the distance measurement process is performed on the target object 1201, the compression rate of the region corresponding to the region where the target object 1201 is detected is switched to the compression rate 3 lower than the compression rate 2. Further, in response to the new detection of the target object 1211, the compression rate of the region corresponding to the region where the target object 1211 is detected is switched to the compression rate 2 lower than the compression ratio 1.

The decoded data 1240 is decoded data obtained by decoding encoded data obtained by encoding the region where the target object 1201 is detected in image data, among the image data, at the compression rate 3, encoding the region where the target object 1211 is detected in the image data at the compression rate 2 and encoding a region, in the image data, other than the region where the target object 1201 is detected and the region where the target object 1211 is detected at the compression rate 1.

The first processing unit 632_1 performs the object detection processing on the entire region of the decoded data 1240 to detect the target objects 1201 and 1211 and a target object 1221. In addition, for the region where the target object 1201 is detected, the second processing unit 632_2 performs the distance measurement process to measure the distance up to the target object, and then the third processing unit 632_3 performs the situation determination process to determine the situation of the target object.

Further, the second processing unit 632_2 performs the distance measurement process on the region where the target object 1211 is detected, and measure the distance up to the target object. In addition, as the distance measurement process is performed on the target object 1211, the compression rate of the region corresponding to the region where the target object 1211 is detected is switched to the compression rate 3 lower than the compression rate 2.

Further, in response to the detection of the new target object 1221, the compression rate of the region corresponding to the region where the target object 1221 is detected is switched to the compression rate 2 lower than the compression rate 1.

Note that in the example of FIG. 12, a process of determining new compression rates 1 to 3 so that the result of the process by each processing unit are equal to or higher than the allowable accuracy is not described. However, the new compression rate 1 may be determined by, for example, calculating the accuracy of the result of the process by the first processing unit 632_1 after the target object 1201 is detected in the decoded data 1220. Similarly, the new compression rate 2 may be determined by, for example, calculating the accuracy of the result of the process by the second processing unit 632_2 after the distance measurement process is performed on the target object 1201 in the decoded data 1230. Similarly, the new compression ratio 3 may be determined by, for example, performing the situation determination process on the target object 1201 in the decoded data 1240 and then calculating the accuracy of the result of the process by the third processing unit 632_3.

As is clear from the above description, in the image processing system 1000 according to the second embodiment, the plurality of processes by the AI are sequentially performed on each region of decoded data generated by decoding encoded image data. Further, when the image quality required for performing the (x+1)-th process is higher than the image quality required for performing the x-th process, the image processing system 1000 according to the second embodiment switches the compression rate of the region corresponding to the result of the x-th process to the switching compression rate.

As described above, in the image processing system 1000 according to the second embodiment, when the plurality of processes by the AI are sequentially performed, the compression rate is switched to the switching compression rate capable of providing image quality required by each process and encoding is performed. Thus, according to the image processing system 1000 of the second embodiment, when the plurality of processes by the AI are sequentially performed, each process may be appropriately performed.

Further, the image processing system 1000 according to the second embodiment determines the compression rate of each region when encoding the image data so that the result of any of the plurality of processes by the AI may obtain the allowable accuracy. Further, the image processing system 1000 according to the second embodiment encodes the image data at the determined compression rate of each region.

As described above, in the image processing system 1000 according to the second embodiment, the accuracy of the results of a plurality of processes by the AI is monitored, and the compression rate after switching of each region is appropriately controlled according to the monitored accuracy. Thus, according to the image processing system 1000 of the second embodiment, even when the image quality of the decoded data is degraded due to a change in the situation around the imaging position, the image quality is improved by changing the compression rate, and thus the allowable accuracy may be obtained as the result of any of the processes by the AI.

For example, according to the second embodiment, it is possible to generate decoded data that may be used in the plurality of processes by the AI.

### Other Embodiments

In each of the above-described embodiments, the encoding apparatuses 120 and 620 and the image analysis apparatuses 130 and 630 are separate apparatuses, but the encoding apparatuses 120 and 620 and the image analysis apparatuses 130 and 630 may be integrated apparatuses.

Further, in each of the above-described embodiments, the imaging apparatus 110 and the encoding apparatuses 120 and 620 are separate apparatuses. However, the image capturing apparatus 110 and the encoding apparatuses 120 and 620 may be an integrated apparatus.

Note that in the case of the integrated apparatus, the apparatus executes, for example, an encoding program including the above-described image analysis program, thereby implementing each function described in each of the above-described embodiments.

Note that in each of the above-described embodiments, some of the functions implemented by the image analysis apparatuses 130 and 630 may be implemented by the encoding apparatuses 120 and 620, and some of the functions implemented by the encoding apparatuses 120 and 620 may be implemented by the image analysis apparatuses 130 and 630.

Further, in the second embodiment described above, a case is described in which different image processing systems are used in the specifying phase and the encoding phase. However, the specifying phase and the encoding phase may be executed using the same image processing system.

Further, in the second embodiment described above, a case is described in which the compression rate is specified by decreasing the compression rate in a stepwise manner in the specifying phase. However, the compression rate may be specified by increasing the compression rate in the stepwise manner.

Further, in the second embodiment described above, the description has been given of the case where the new compression rate is determined after the compression rate is switched to the switching compression rate in the encoding phase. However, in a case where a new compression rate has already been determined, the compression rate may be switched to the new compression rate that has already been determined when switching to the switching compression rate.

Further, in the second embodiment described above, the compression rate is determined for each region in which the target object is detected. However, as in the first embodiment described above, the compression rate may be determined for each set granularity of the compression rate.

Further, the method of determining a new compression rate by the accuracy monitoring unit described in each of the above embodiments is merely an example. For example, the compression rate may be determined based on information for determining the compression rate obtained by analyzing a recognition state or a recognition process by the AI and information indicating a transition of the accuracy of the result of the process.

For example, when the compression rate corresponding to the processing unit that performs a process on a predetermined region is determined, the compression rat may be increased (or decreased) in a stepwise manner while observing a transition of the accuracy of the result of the process by the processing unit. Alternatively, the compression rate may be determined based on information for determining the compression rate, which is obtained by analyzing a process state or a processing process of the processing unit that performs a process on a predetermined region.

Alternatively, the compression rate may be determined based on information for determining the compression rate, which is obtained by analyzing the process state or the processing process of the processing unit that performs the process on the predetermined region, and the transition of the accuracy of the result of the process performed by the processing unit different from the processing unit that determines the compression rate.

Further, the recognition process by the AI described in each of the above-described embodiments may include an analysis process or the like for obtaining a result based on an analysis by a computer or the like, in addition to the deep learning process.

Further, although not described in each of the above-described embodiments, some regions in the image data may include a region where all the processing units perform a process and a region where only some of the processing units perform a process. For the region where only the some of the processing units performs the process, the compression rate of that region may be determined based on the result of the process by the some of the processing units. Alternatively, the compression rate of that region may be determined by including the result of the process by the processing unit that does not perform the process.

Note that the present disclosure is not limited to configurations indicated here such as the configurations described in the above embodiments and combinations with other elements. These points may be changed without departing from the scope of the present disclosure, and may be appropriately determined according to the application form.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing system comprising:
a memory; and
a processor coupled to the memory and configured to;
encode, when a plurality of process are performed, by AI, on decoded data which is generated by decoding image data which is encoded, the image data at a compression rate which is determined such that a result of each of the plurality of process acquires a specific accuracy.

2. The image processing system according to claim 1, wherein the processor is further configured to monitor the result of the plurality of processes by the AI.

3. The image processing system according to claim 2, wherein, when the plurality of processes by the AI are performed in parallel and the result of one process of the plurality of processes performed by the AI is equal to or less than an allowable accuracy, the processor is configured to determine a new compression rate such that the result of the one process is equal to or more than the allowable accuracy.

4. The image processing system according to claim 3, wherein, when the plurality of processes by the AI are performed in parallel and a minimum accuracy among accuracies of results of the plurality of processes performed by the AI is equal to or higher than the allowable accuracy, the processor is configured to determine a new compression rate such that the minimum accuracy approaches the allowable accuracy.

5. The image processing system according to claim 2, wherein the processor is configured to switch, when the plurality of processes are sequentially performed by the AI and image quality for performing the (x+1)-th process is to be higher than image quality for performing the x-th process, switches the compression rate of a region corresponding to the result of the x-th process to a compression rate lower than the compression rate at the time of performing the x-th process.

6. The image processing system according to claim 5, wherein rule information in which each switching rate which provides the image quality for each of the plurality of processes by the AI, a condition for switching to each switching rate, and each region to be switched to each switching rate are defined, and
the processor is configured to switch the compression rate of each region based on results of the plurality of processes by the AI and the rule information.

7. The image processing system according to claim 6, wherein, when the result of one of the plurality of processes by the AI is equal to or less than the allowable accuracy, the processor is configured to determine a new compression rate for the region in which the process is performed so that the result of the process is equal to or more than the allowable accuracy.

8. The image processing system according to claim 6, wherein, when a minimum accuracy among accuracies of results of the plurality of processes performed by the AI is equal to or higher than the allowable accuracy, the processor is configured to determine a new compression rate for the region such that the minimum accuracy approaches the allowable accuracy.

9. An encoding method comprising:
generating decoded data by decoding image data which is encoded; and
encoding, when a plurality of process are performed, by AI, on the decoded data, the image data at a compression rate which is determined such that a result of each of the plurality of process acquires a specific accuracy.

10. A non-transitory computer readable recording medium storing an encoding program causing a computer to execute a process of:
generating decoded data by decoding image data which is encoded; and
encoding, when a plurality of process are performed, by AI, on the decoded data, the image data at a compression rate which is determined such that a result of each of the plurality of process acquires a specific accuracy.
